(19) United States
(12) Patent Application Publication
(10) Pub. No.: US 2015/0226907 A1
(43) Pub. Date: Aug. 13, 2015

(54) LIGHT GUIDE MODULE

(71) Applicant: E Ink Holdings Inc., Hsinchu (TW)

(72) Inventors: Chia-Chuang HU, HSINCHU (TW); Shu-Li HSIAO, HSINCHU (TW)

(21) Appl. No.: 14/555,682

(22) Filed: Nov. 27, 2014

(30) Foreign Application Priority Data
Feb. 7, 2014 (TW) 103104126

(51) Int. Cl. F21V 8/00; G04G 9/00; F21S 8/10

(52) U.S. Cl. CPC G02B 6/0045; G02B 6/0073; F21S 48/00; G04G 9/0041; G02B 6/002

(57) ABSTRACT

A light guide module includes a light guide plate and a light source. The light guide plate has an active area and a light-mixed area. The active area has a centroid. The light source faces the light-mixed area, and the optical axis of the light source is not through the centroid of the active area, such that a perpendicular distance is formed between the optical axis of the light source and the centroid of the active area.

### RELATED APPLICATIONS

This application claims priority to Taiwanese Application Serial Number 103104126, filed Feb. 7, 2014, which is herein incorporated by reference.

### BACKGROUND

1. Field of Invention

The present invention relates to a light guide module.

2. Description of Related Art

With the development of science and technology, display devices and panel lights that utilize light guide plates have become commonplace. A light source (e.g., a LED) may usually be disposed adjacent to a side surface (light incident surface) of a light guide plate. When the light source emits light, the light may enter the side surface of the light guide plate, and subsequently the front surface (light emitting surface) of the light guide plate emits light.

Snell's Law limits the physical properties of the LED light source. After the light emitted by the LED light source enters the light guide plate, the distribution angle of the light is limited to 78 degrees for polycarbonate (PC) material. As a result, the light is not uniformly distributed in the light guide plate, and a dark area is formed adjacent to the light incident position of the light guide plate. Moreover, if the light guide plate having micro structures on the light incident surface is used, the distribution angle of the light in the light guide plate may be expanded to 140 degrees. However, the area of the optical coupling area (light-mixed area) of the light guide plate needs to be increased to prevent affecting the light distribution of the active area of the light guide plate.

As a result, for a conventional light guide module having the light guide plate and the LEO light source, it is difficult to improve the uniformity of the light due to the dark area in the active area of the light guide plate. Or, the uniformity of the light in the active area may be improved by increasing the area of the light-mixed area of the light guide plate, but the manufacturing cost of the light guide plate is increased.

### SUMMARY

An aspect of the present invention is to provide a light guide module.

According to an embodiment of the present invention, a light guide module includes a light guide plate and a light source. The light guide plate has an active area and a light-mixed area. The active area has a centroid. The light source faces the light-mixed area, and the optical axis of the light source is not through the centroid of the active area, such that a perpendicular distance is formed between the optical axis of the light source and the centroid of the active area.

In one embodiment of the present invention, the shape of the active area is round, and the centroid of the active area is a circle center.

In one embodiment of the present invention, the shape of the active area is elliptical, and the centroid of the active area is the intersection point of the long axis and the short axis of the active area.

In one embodiment of the present invention, the shape of the light-mixed area is triangular or n-sided polygonal, where n is a natural number greater than or equal to four.

In one embodiment of the present invention, the shape of the light guide plate includes round, elliptical, triangular, n-sided polygonal, or combinations thereof, where n is a natural number greater than or equal to four.

In one embodiment of the present invention, the light guide plate has at least one first sidewall and a plurality of second sidewalls that are adjacent to each other. The first side I surrounds the active area. Two ends of the first sidewall are respectively adjacent to two of the second side ails. The second sidewalis surround the light-mixed area, and one of the second sidewalis faces the light source.

In one embodiment of the present invention, the number of the second sidewalis is two, and an included angle is formed between the two second sidewalls.

In one embodiment of the present invention, the number of the second sidewalls is four. A first included angle is formed between two of the four second sidewalls that are adjacent to the first sidewall, and a second included angle is formed between the other two second sidewalls.

In one embodiment of the present invention, the first included angle is in a range from 90 to 140 degrees, and the second included angle is in a range from 60 to 150 degrees.

In one embodiment of the present invention, the first sidewall and one of the second sidewalls are coplanar.

In one embodiment of the present invention, the light guide plate has a through round opening, such that the active area is ring-shaped.

In one embodiment of the present invention, the light guide module is a car lamp assembly.

In one embodiment of the present invention, the light guide plate has a through hole, such that a spindle penetrates outwards the light guide plate through the through hole. The spindle is connected to an hour hand, a minute hand, a second hand, or combinations thereof.

In one embodiment of the present invention, the light guide module is a front light assembly of a watch.

In one embodiment of the present invention, the light source is a light emitting diode.

In one embodiment of the present invention, when the light source emits light, a portion of the light of the light source is not reflected by the light-mixed area and enters the active area, and another portion of the light of the light source is reflected by the light-mixed area and enters the active area.

In the aforementioned embodiments of the present invention, the optical axis of the light source is not through the centroid of the active area. Therefore, when the light source emits light, a portion of the light of the light source may directly enters the active area from the light-mixed area, and is not reflected by the sidewalls of the light guide plate surrounding the light-mixed area. Moreover, another portion of the light of the light source may be reflected to the active area by the sidewalls of the light guide plate surrounding the light-mixed area. As a result, when the light guide module is in operation, the light may be uniformly distributed in the light guide plate to form a surface light source to emit light. Furthermore, the area of the light-mixed area of the light guide plate may be decreased, so that the cost of the light guide plate may be reduced, and degree of freedom for stack structure designs of products is increased.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 is a top view of a light guide module according to an embodiment of the present invention;

FIG. 2 is a top view of a light guide module according to an embodiment of the present invention;

FIG. 3 is a top view of a light guide module according to an embodiment of the present invention;

FIG. 4 is a top view of a light guide module according to an embodiment of the present invention;

FIG. 5 is a top view of a light guide module according to an embodiment of the present invention;

FIG. 6 is a top view of a light guide module according to an embodiment of the present invention;

FIG. 7 is a top view of a light guide module according o an embodiment of the present invention; and

FIG. 8 is a top view of a light guide module according to an embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

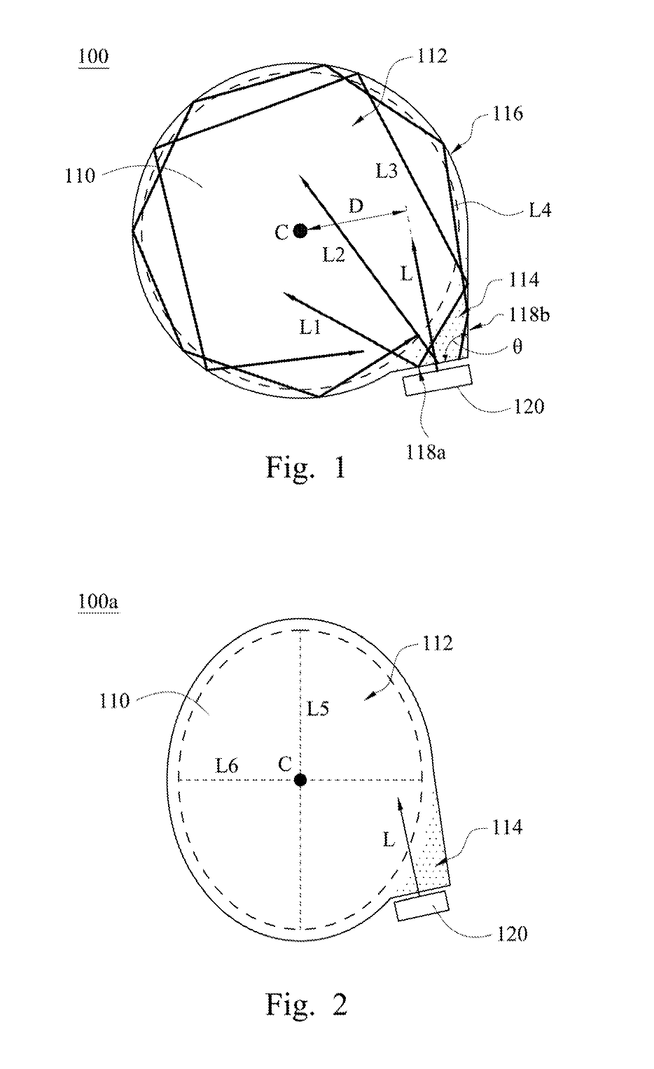

FIG. 1 is a top view of a light guide module 100 according to an embodiment of the present invention. As shown in FIG. 1, the light guide module 100 includes a light guide plate 110 and a light source 120. The light guide plate 110 has an active area 112 and a light-mixed area 114. The active area 112 is referred to as a region in the dotted line shown in FIG. 1. The light-mixed area 114 is located at a side position of the light guide plate 110, and is referred to as a region with dots shown in FIG. 1. When the light guide plate 110 is used in an electronic device, the active area 112 may be referred to as a region that is not shielded by the housing of the electronic device, and the light-mixed area 114 may be shielded by the housing of the electronic device. That is to say, when the light guide plate 110 emits light by the light source 120, users only see the active area 112 of the light guide plate 110.

The active area 112 of the light guide plate 110 has a centroid C. The light source 120 faces the light-mixed area 114, and the optical axis L of the light source 120 is not through the centroid C of the active area 112, such that a perpendicular distance D is formed between the optical axis L of the light source 120 and the centroid C of the active area 112. When the light source 120 emits light, a portion of the light (e.g. lights L1, L2) of the light source 120 are not reflected by the light-mixed area 114 and enter the active area 112, and another portion of the light (e.g., lights L3, L4) of the light source 120 is reflected by the light-mixed area 114 and enter the active area 112 (the shape of the active area 112 is round).

In this embodiment, the light source 120 may be, but not limited to a light emitting diode (LED). The shape of the active area 112 is round, and the centroid C of the active area 112 is the circle center of the active area 112 Moreover, the shape of the light-mixed area 114 is triangular. The shape of the light guide plate 110 is a combination of round and triangular. However, in other embodiment, the active area 112, the light-mixed area 114, and the light guide plate 110 may have other shapes, and the present invention is not limited in this regard. For example, the shape of the light-mixed area 114 may be n-sided polygonal, where n is a natural number greater than or equal to four. The shape of the light guide plate 110 may be round, elliptical, triangular, n-sided polygonal, or combinations thereof, where n is a natural number greater than or equal to four.

In this embodiment, the light guide plate 110 has a first sidewall 116 and two adjacent second sidewalls 118a, 118b. The first sidewall 116 surrounds the active area 112, and two ends of the first sidewall 116 are respectively adjacent to the second sidewalls 118a, 118b. The second sidewalls 118a, 118b surround the light-mixed area 114, and the second sidewall 118a faces the light source 120. An included angle θ is formed between the second sidewalls 118a, 118b.

The optical axis L of the light source 120 is not through the centroid C of the active area 112. Therefore, when the light source 120 emits light, a portion of the light (e.g., lights L1, L2) of the light source may directly enters the active area 112 from the light-mixed area 114, and is not reflected by the second sidewalls 118a, 118b of the light guide plate 110 surrounding the light-mixed area 114. As a result, the brightness of the light guide plate 110 may be improved. Moreover, another portion of the light (e.g., lights L3, L4) of the light source 120 may be reflected to the active area 112 by the second side ails 118a, 118b surrounding the light-mixed area 114. Since the lights L3, L4 comply with the total reflection condition, the lights L3, L4 is transmitted along the first sidewall 116 of the light guide plate 110 to surround the light guide plate 110. As a result, when the light guide module 100 is in operation, the lights Li, L2, L3, L4 may be uniformly distributed in the light guide plate 110 to form a surface light source to emit light. Furthermore, the area of the light-mixed area 114 of the light guide plate 110 may be decreased, so that the cost of the light guide plate 110 may be reduced, and degree of freedom for stack structure designs of products is increased.

The light guide module 100 may be utilized in a lighting fixture, a front light assembly of a watch, a backlight module of a display device (e.g., an LCD display device), or a front light assembly of a display device (e.g., an electronic paper display device).

It is to be noted that the connection relationships of the elements described above will not be repeated in the following description. In the following description, other types of the light guide module will be described.

FIG. 2 is a top view of a light guide module 100a according to an embodiment of the present invention. The light guide module 100a includes the light guide plate 110 and the light source 120. The light guide plate 110 has the active area 112 and the light-mixed area 114. The optical axis L of the light source 120 is not through the centroid C of the active area 112. The difference between this embodiment and the embodiment shown in FIG. 1 is that the shape of the active area 112 of the light guide plate 110 is elliptical, and the centroid C of the active area 112 is the intersection point of the long axis L5 and the short axis L6 of the active area 112.

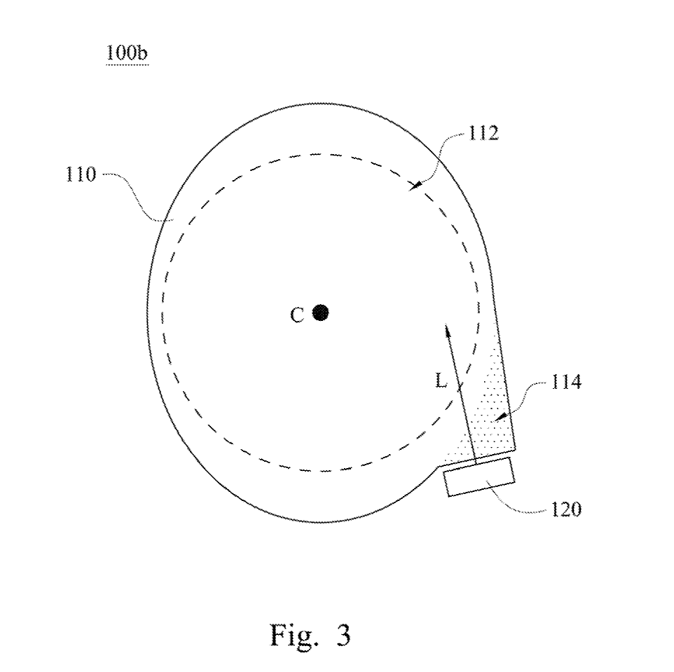

FIG. 3 is a top view of a light guide module 100b according to an embodiment of the present invention. The light guide module 100b includes the light guide plate 110 and the light source 120. The light guide plate 110 has the active area 112 and the light-mixed area 114. The optical axis L of the light source 120 is not through the centroid C of the active area 112. The shape of the active area 112 of the light guide plate 110 is round, and the shape of the light-mixed area 114 is triangle. The difference between this embodiment and the embodiment shown in FIG. 1 is that the shape of the light guide plate 110 is a combination of ellipse and triangle.

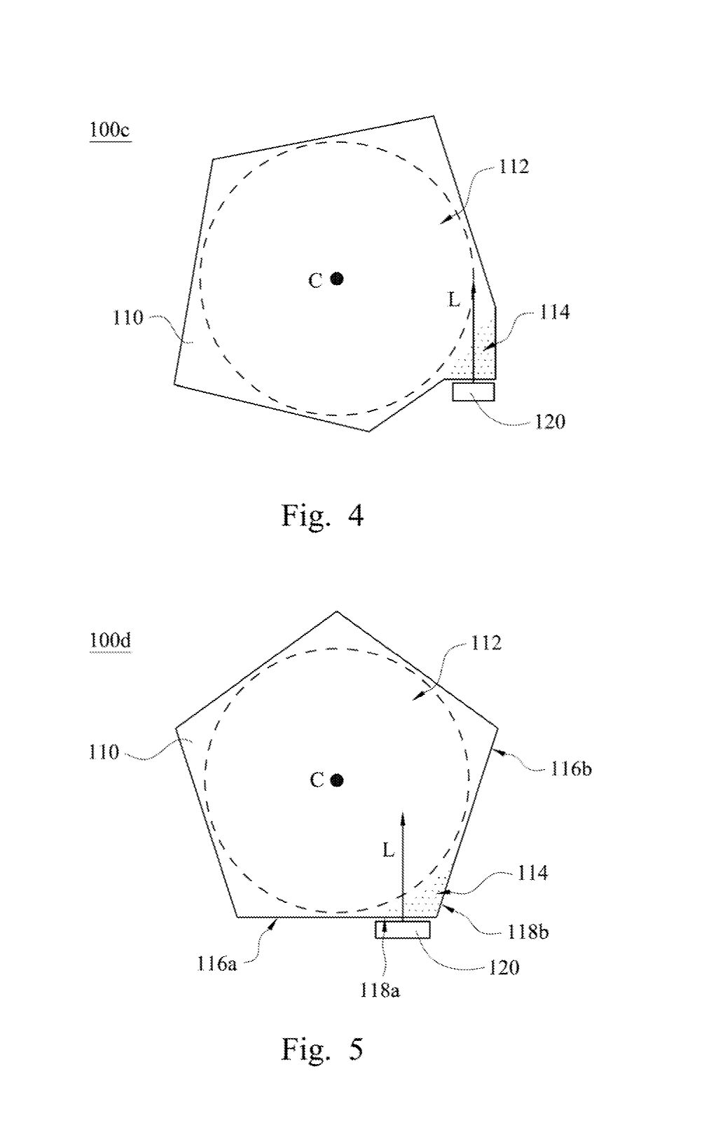

FIG. 4 is a top view of a light guide module 100c according to an embodiment of the present invention. The light guide module 100c includes the light guide plate 110 and the light source 120. The light guide plate 110 has the active area 112 and the light-mixed area 114. The optical axis L of the light source 120 is not through the centroid C of the active area 112. The shape of the active area 112 of the light guide plate 110 is round, and the shape of the light-mixed area 114 is triangle. The difference between this embodiment and the embodiment shown in FIG. 1 is that the shape of the light guide plate 110 is a combination of six-sided polygonal and triangular.

FIG. 5 is a top view of a light guide module 100d according to an embodiment of the present invention. The light guide module 100d includes the light guide plate 110 and the light source 120. The light guide plate 110 has the active area 112 and the light-mixed area 114. The optical axis L of the light source 120 is not through the centroid C of the active area 112. The shape of the active area 112 of the light guide plate 110 is round. The difference between this embodiment and the embodiment shown in FIG. 1 is that the shape of the light guide plate 110 is five-sided polygonal, the first sidewall 116a and the second sidewall 118a are coplanar, and the first sidewall 116b and the second sidewall 118b are coplanar. The light guide plate 110 does not need to be designed with a protruding region, so that the manufacturing cost of the light guide plate 110 may be reduced.

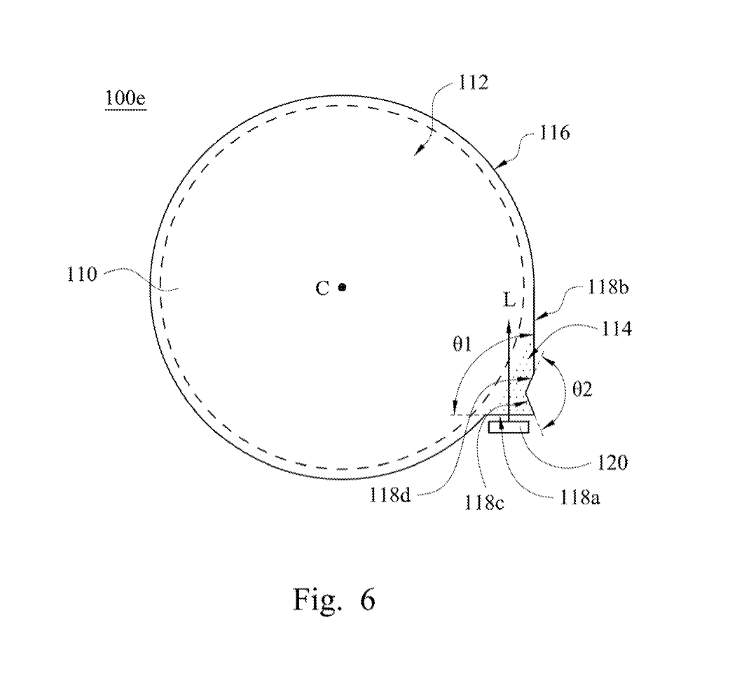

FIG. 6 is a top view of a light guide module 100e according to an embodiment of the present invention. The light guide module 100e includes the light guide plate 110 and the light source 120. The light guide plate 110 has the active area 112 and the light-mixed area 114. The optical axis L of the light source 120 is not through the centroid C of the active area 112. The shape of the active area 112 of the light guide plate 110 is round. The difference between this embodiment and the embodiment shown in FIG. 1 is that the shape of the light-mixed area 114 is five-sided polygonal, and the light guide plate 110 has second sidewalls 118a, 118b, 118c, 118d. A first included angle θ1 is formed between the second sidewalls 118a, 118b that are adjacent to the first sidewall 116, and a second included angle θ2 is formed between the other second sidewalls 118c, 118d. The first included angle θ1 may be in a range from 90 to 140 degrees, and the second included angle θ2 may be in a range from 60 to 150 degrees. The first and second included angles θ1, θ2 may be varied as deemed necessary by designers. Designers may adjust the values of first and second included angles θ1, θ2 to change the light utilization efficiency of the light guide module 100e.

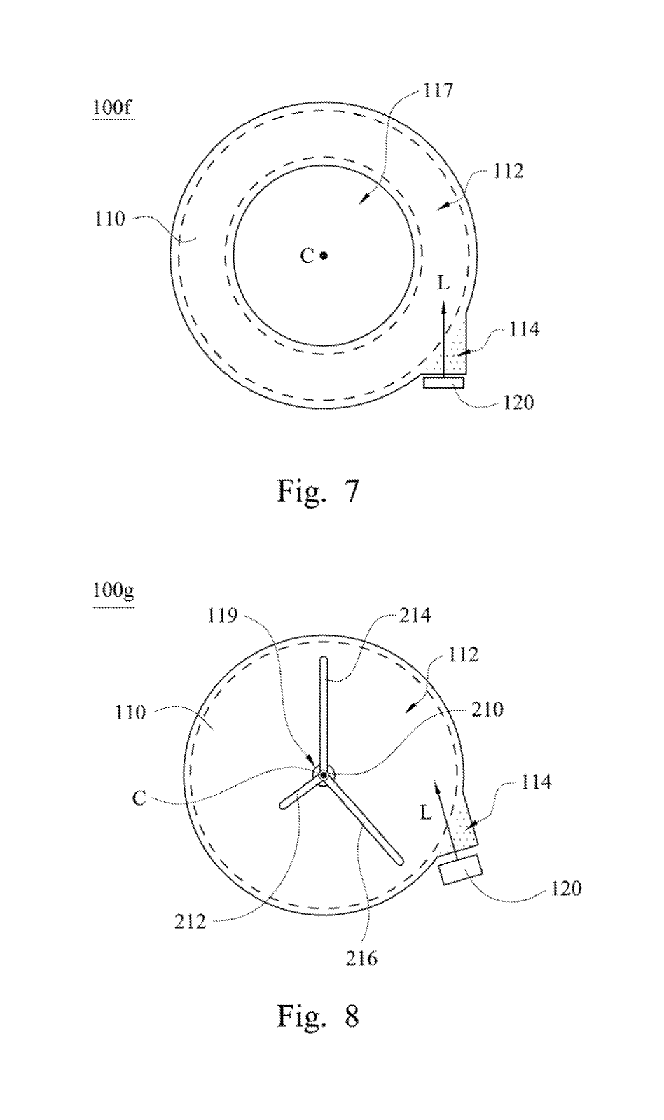

FIG. 7 is a top view of a light guide module 100f according to an embodiment of the present invention. The light guide module 100f includes the light guide plate 110 and the light source 120. The light guide plate 110 has the active area 112 and the light-mixed area 114. The optical axis L of the light source 120 is not through the centroid C of the active area 112. The shape of the light-mixed area 114 is triangular. The difference between this embodiment and the embodiment shown in FIG. 1 is that the light guide plate 110 has a through round opening 117, such that the active area 112 is ring-shaped. When the light source 120 emits light, the ring-shaped active area 112 may emit light. In this embodiment, the light guide module 100f may be, but not limited to a car lamp assembly.

FIG. 8 is a top view of a light guide module 100g according to an embodiment of the present invention. The light guide module 100g includes the light guide plate 110 and the light source 120. The light guide plate 110 has the active area 112 and the light-mixed area 114. The optical axis L of the light source 120 is not through the centroid C of the active area 112. The shape of the active area 112 of the light guide plate 110 is round, and the shape of the light-mixed area 114 is triangular. The difference between this embodiment and the embodiment shown in FIG. 1 is that the light guide plate 110 has a through hole 119, such that a spindle 210 can penetrate outwards the light guide plate 110 through the through hole 119. The spindle 210 is connected to an hour hand 212, a minute hand 214, a second hand 216, or combinations thereof. In this embodiment, the light guide module 100g may be a front light assembly of a watch, and provides illumination function for the watch.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A light guide module comprising:
a light guide plate having an active area and a light-mixed area, wherein the active area has a centroid; and
a light source facing the light-mixed area, wherein an optical axis of the light source is not through the centroid of the active area, such that a perpendicular distance is formed between the optical axis of the light source and the centroid of the active area.

2. The light guide module of claim 1, wherein a shape of the active area is round, and the centroid of the active area is a circle center.

3. The light guide module of claim 1, wherein a shape of the active area is elliptical, and the centroid of the active area is an intersection point of a long axis and a short axis of the active area.

4. The light guide module of claim 1, wherein a shape of the light-mixed area is triangular or n-sided polygonal, where n is a natural number greater than or equal to four.

5. The light guide module of claim 1, wherein a shape of the light guide plate comprises round, elliptical, triangular, n-sided polygonal, or combinations thereof, where n is a natural number greater than or equal to four.

6. The light guide module of claim 1, wherein the light guide plate has at least one first sidewall and a plurality of second sidewalls that are adjacent to each other, the first sidewall surrounds the active area, two ends of the first sidewall are respectively adjacent to two of the second sidewalls, the second sidewalls surround the light-mixed area, and one of the second sidewalls faces the light source.

7. The light guide module of claim 6, wherein the number of the second sidewalls is two, and an included angle is formed between the two second sidewalls.

8. The light guide module of claim 6, wherein the number of the second sidewalls is four, a first included angle is formed between two of the four second sidewalls that are adjacent to the first sidewall, and a second included angle is formed between the other two second sidewalls.

9. The light guide module of claim 8, wherein the first included angle is in a range from 90 to 140 degrees, and the second included angle is in a range from 60 to 150 degrees.

10. The light guide module of claim 6, wherein the first sidewall and one of the second sidewalls are coplanar.

11. The light guide module of claim 6, wherein the light guide plate has a through round opening, such that the active area is ring-shaped.

12. The light guide module of claim 11, wherein the light guide module is a car lamp assembly.

13. The light guide module of claim 1, wherein the light guide plate has a through hole, such that a spindle penetrates outwards the light guide plate through the through hole, and the spindle is connected to an hour hand, a minute hand, a second hand, or combinations thereof.

14. The light guide module of claim 13, wherein the light guide module is a front light assembly of a watch.

15. The light guide module of claim 1, wherein the light source is a light emitting diode.

16. The light guide module of claim 1, wherein when the light source emits light, a portion of the light of the light source is not reflected by the light-mixed area and enters the active area, and another portion of the light of the light source is reflected by the light-mixed area and enters the active area.
